(19) United States
(12) Patent Application Publication
(10) Pub. No.: US 2026/0104344 A1
(43) Pub. Date: Apr. 16, 2026

(54) OPTICAL SYSTEM AND METHODS FOR MEASURING LIGHT

(71) Applicant: AGILENT TECHNOLOGIES, INC., Santa Clara, CA (US)

(72) Inventors: Lingbo Kong, San Diego, CA (US); Nan Li, San Diego, CA (US); Longbin Fang, Hangzhou (CN); Xiaobo Wang, San Diego, CA (US); Yan Wu, Hangzhou (CN)

(21) Appl. No.: 19/130,490

(22) PCT Filed: Nov. 6, 2023
(86) PCT No.: PCT/US2023/036886

§ 371 Date: May 15, 2025

Related U.S. Application Data
(60) Provisional application No. 63/427,754, filed on Nov. 23, 2022.

(51) Int. Cl. G01N 15/1434; G01N 15/10; G01N 15/14

(52) U.S. Cl. CPC G01N 15/1434; G01N 15/1459; G01N 2015/1006; G01N 2015/1452

(57) ABSTRACT

Systems and methods for measuring light, which collect and measure light emitted from different positions along the length of a flow cell using shared collection and magnification optics, a light splitting module that splits magnified light into a plurality of wavelength ranges, and an array of spherical lenses that direct light of different wavelength and emission position to an array of detectors.

### FIELD OF THE INVENTION

The invention relates to systems and methods for measuring light emission, and more specifically to an optical system for measuring light emitted from fluorescently labeled biological cells, which can be used to analyze biological cell populations.

### BACKGROUND OF THE INVENTION

Flow cytometry is a technique used to detect and measure physical and chemical characteristics of a population of biological cells. Broadly, the process involves labeling cell biomarkers with fluorescent dyes and streaming the cells through a flow cell. As cells pass through the flow cell, they are struck by a light source tuned to a frequency that causes the fluorescent dye to fluoresce. This fluorescence is measured to reveal information about the cell population and characteristics.

In practice, most flow cytometry involves multicolor flow cytometry, which examines mixed populations of cells, such as different cell types found in blood and tissue. These cell types are generally distinguished from one another by labeling antibody or antibody fragments that are specific to different biomarkers with different fluorescent dyes that fluoresce at different wavelengths. Due to the complexity of biological systems, the number of biomarkers targeted for labeling has drastically increased. Likewise, more and more fluorescent dyes have become available which significantly expands capabilities to analyze more biomarkers in one experiment.

In addition, advanced electronics systems have been designed to acquire data from more fluorescent channels simultaneously and with extraordinary speed. However, even with the advanced electronics, conventional flow cytometers are still limited in capacity in that they are based on splitting the collected fluorescent signals into discrete channels and use an individual channel covering a narrow wavelength band for one specific fluorescent dye and thus some fluorescent dyes which have similar emission spectrum cannot be used at the same time in one experiment. Also, the capability to simultaneously detect some fluorescent dyes which have significant spectrum overlaps is significantly sacrificed, if ever possible, using a conventional flow cytometer. In recent years, the development of spectral flow cytometers has resolved the limitation of the conventional flow cytometer by collecting the light across a wide wavelength range, containing multiple discrete channels where light from each channel is collected collectively (i.e. spectrum data). A de-convolution algorithm is applied to the collected spectrum data of the sample stained with multiple fluorescent dyes (multi-stained sample) to calculate the fluorescence signal intensity of each fluorescence dye used in the sample, using the spectrum data from each individual fluorescent dye (single-stained sample) as a reference. However, the key challenges for designing a spectral flow cytometer are: (1) how to collect the emitted fluorescent light from the cells or particles as the fluorochromes are excited by each laser and (2) how to disperse or split the emitted fluorescent light into a continuous spectrum across the large wavelength range (i.e. 360-900 nm ) and to detect the dispersed light within a specific narrow wavelength range (i.e. one fluorescence detection channel).

For spectral flow cytometers and majority of flow cytometers, light collection is achieved through the use of optical fibers. This method uses light collection optics to collect the fluorescence light from each of different lasers which are usually separated in space along the flow channel and image them into different focusing spots. For each excitation laser, an optical fiber is needed to collect fluorescent light excited by it. As such, for N number of lasers, N optical fibers are used to collect fluorescent light excited by all the lasers. The light collection optics may be a specially designed objective, or multiple optical elements (e.g. lenses), which collect emitted light from a single laser and focus it to a single focusing spot to image all the emitted lights to different focusing spots. An array of optical fiber is placed at the focusing plane with each fiber matching one focusing spot from one laser and is used to guide the light at each focus spot to go through light splitting components (and then the split or dispersed light at different and continuous wavelength ranges will propagate into an array of discrete photodetectors for each laser). In order to couple the light into the optical fiber array placed at the focusing plane close to light collection optics, the light collection optics system usually is designed with a low magnification (e.g., <10×) and short focusing distance. For example, the laser is usually spatially separated along the flow channel in a flow cytometer from 50 μm to 200 μm. An array of optical fiber is typically spaced from 500 μm to 1 mm. Therefore, the magnification of the light collection optics cannot be too high. Otherwise, the light at the focus plane cannot be effectively coupled into the optical fibers. The alignment of the optical fiber array to each focused light spot is very critical and requires very high mechanical alignment accuracy. Yet even with a well-aligned optical fiber array, the focused light spot can vary since the position of each cell or particle passing through the flow cell varies. This contributes to the variation of the light signal intensity collected by each optical fiber, which leads to larger Coefficient of Variation (CV) of the detected fluorescence signals. The CV could become unreasonably large especially at higher sample flow rate. The higher sample flow rate, the larger the core diameter of the sample stream inside the flow channel. The cells and particles have larger room deviated from the center of the sample core stream. Therefore, the focus spot after the light collection optics changes more in position, relative to the optical fiber that is fixed in position. And as a result, the light intensity coupled into the optical fiber at each focus spot varies and leads to larger CV. Therefore, using optical fibers in the light collection system results in large (e.g. worse) signal CV, especially with higher sample flow rate for high throughput flow cytometry analysis. In addition, because of small numerical apertures of the optical fibers (see, e.g., Numerical aperture in fiber optics (questtel.com)), the overall light collection efficiency of the system is reduced, which leads to decreased fluorescent signal detection sensitivity. Furthermore, the optical fiber also degrades with time and frequent maintenance, or repair service is needed. Such constant maintenance of the optical fibers adds extra cost of ownership. Another issue associated with the optical fiber approach is that one laser needs one set of light splitting optics, which may involve light dispersion elements, and/or optical components such dichroic mirrors and bandpass filters.

When the number of lasers increases, the number of optic components used for dispersing or splitting light increases, the system becomes very complex, and the cost increases significantly.

Two general methods—the optical filter method and the optical dispersion method—have been used for splitting and dispersing light in spectral and other flow cytometers. The optical filter method is to use optical components such dichroic mirrors and bandpass filters to split light into different wavelength ranges. As mentioned above, in typical flow cytometers, one laser needs one set of such optical components. When the number of lasers increases, the number of such optic components increases, the system becomes very complex, and the cost increases significantly.

The optical dispersion method uses an optical element which can disperse the light into a continuous spectrum, such as a dispersive prism or a diffraction grating. In this type of design, the dispersion pattern of the light is fixed (i.e. from short wavelength to long wavelength) and usually is non-linear (i.e. not equally spread spatially) across the entire spectrum. Thus, each detection channel, i.e. a specific wavelength range of the dispersed light, would have limit in the narrowness of the wavelength. In addition, as the spread of the light out of the optical light dispersion element is usually quite narrow in space, this makes it very difficult to physically put an array of optical detectors to detect the light in each narrow wavelength range. In one approach, a multi-channel photomultiplier (PMT) is used for light detection, with multi-channel PMT being very expensive. As the number of lasers and fluorescence channels increase, the design of such system becomes much more complicated. For example, an array of light dispersion elements may be required to achieve narrow wavelength range for detection channels, where each dispersion element needs to be arranged with high mechanical tolerance (i.e. high manufacturing cost). In addition to the system complexity, the array of optical dispersion elements reduces the transmission of the collected light, leading to significant light loss and reduced fluorescence signal detection sensitivity.

Accordingly, there remains a need for new systems and methods for use in flow cytometry that increases the number of fluorescent dyes available in a single experiment.

### SUMMARY OF THE INVENTION

The invention addresses the above-described deficiencies in the art and provides related benefits. This is achieved in one embodiment through an optical system for measuring light, which includes: a flow cell having a length and a width that permits passage of biological cells; a plurality of different excitation light sources that direct light to different positions along the length of the flow cell; shared light collection optics and shared magnification optics configured to collect light emitted from the different positions of the flow cell and to magnify and focus the collected light on a focal plane of a specified distance according to different wavelength ranges, and to different positions along the focal plane according to each of the different positions of the flow cell from which light is emitted; a light splitting module having light splitting optics arranged in a way so that the light splitting optics are shared by the magnified light emitted from each of the different positions of the flow cell, and the light splitting optics are configured to split the magnified light emitted from each of the different positions of the flow cell into an array of channels, each channel corresponding to a separate wavelength range; an array of detection modules, where each detection module is dedicated to an individual channel with the array of channels, and where each detection module includes an array of spherical lenses located at each of the different focusing distances along a direction of propagation of the collected light for each of the different wavelength ranges, each of the spherical lenses within the array configured to receive the magnified light emitted from one of the different positions of the flow cell and to direct the received magnified light to a predetermined area on a corresponding photodetector; and an array of photodetectors configured to measure the magnified light directed from each of the spherical lenses, thereby one photodetector measuring the collected light within one wavelength range from one of the different positions of the flow cell.

In some embodiments, the plurality of excitation light sources include a plurality of laser light sources. In further embodiments, the laser light sources are shaped by beam shaping optics to designed geometries and focused to different positions inside the flow cell.

In some embodiments, the plurality of different excitation light sources includes more than 5 excitation light sources. In further embodiments there are more than 10 excitation light sources. In further embodiments there are optionally more than 15 excitation light sources.

In some embodiments the distance between neighboring positions on the flow cell to which light is directed from the excitation light sources is from 50 μm to 250 μm. In further embodiments the distance is from 50 μm to 150 μm In some embodiments, the shared light collection optics direct light to the shared magnification optics, which magnify vertical separation distances between light emitted from the different positions of the flow cell. In further embodiments, the shared magnification optics include a set of objective lenses having a magnification of 20× to 250×, optionally 30× to 100×, optionally 35× to 75×, optionally 40× to 60×. Exemplary vertical separation distances between neighboring light at the array of spherical lenses includes less than 30 mm. In some embodiments, the vertical separation distances at the array of spherical lenses are from 1 mm to 10 mm.

As a nonlimiting example, the plurality of excitation light sources direct light to neighboring positions along the flow cell that are 100 μm apart, the shared magnification optics have 55× magnification, and neighboring light received at the array of spherical lenses is separated 5.5 mm apart.

In some embodiments, the light splitting module propagates light through a series of dichroic mirrors and band pass filters to split the magnified light into the plurality of different wavelength ranges. In some embodiments, the plurality of wavelength ranges includes wavelength ranges from 320 nm to 1000 nm.

In some embodiments the excitation light sources include lasers of 349 nm, 405 nm, 488 nm, 561 nm, and 637 nm. As a nonlimiting example, the different wavelength ranges include 372 nm to 389 nm, 417 nm to 431 nm, 431 nm to 449 nm, 449 nm to 461 nm, 461 nm to 477 nm, 500 nm to 517 nm, 517 nm to 534 nm, 534 nm to 552 nm, 573 nm to 592 nm, 592 nm to 608 nm, 608 nm to 628 nm, 650 nm to 672 nm, 672 nm to 691 nm, 691 nm to 709 nm, 709 nm to 726 nm, 726 nm to 744 nm, 744 nm to 770 nm, 770 nm to 798 nm, and 798 nm to 832 nm.

In some embodiments, the light emitted from the different positions wobbles in response to varying fluidic properties through the flow channel and/or changes in positioning of excitation light sources. In further embodiments, the spherical lenses with each array direct wobbling light to a same area of the photodetector where the detected light is stable.

In some embodiments the photodetector system includes a silicon photomultiplier (SiPM) detector.

In some embodiments, each spherical lens is specifically designed so that the diameter of a spot of light on the photodetector corresponds with an effective detection area of the detector.

In some embodiments, the collection optics and spherical mirror are specified such that a detected light spot on a corresponding photodetector is not affected by a positional change of the collected light focused on the spherical lens.

In some embodiments, the spherical lens is designed so that the detected light signal on the corresponding photodetector is not sensitive to a horizontal position fluctuation of the biological cells inside the flow channel.

In some embodiments the set alignment optics are configured to align the magnified light into the light splitting module and the arrays of spherical lenses.

In some embodiments, any of the optical systems is integrated into a flow cytometer and thus a flow cytometer can be provided with the optical system.

In a related aspect of the invention, a method of characterizing a biological cell is provided, which includes: passing a biological cell through a flow cell, the biological cell labeled with a plurality of fluorescent markers that fluoresce at different wavelengths when excited, the labels attached to or absent from cellular moieties that together characterize the biological cell by the presence, absence or abundance of the markers; directing light to different positions along a length of the flow cell as the biological cell passes the different positions; collecting light emitted from each of the different positions of the flow cell as the biological cell passes; magnifying and focusing the collected light to different focusing distances according to different wavelength ranges, and to different positions within each focusing distance according to each of the different positions of the flow cell from which the collected light is emitted; splitting the magnified light into a plurality of different wavelength ranges, wherein the different fluorescent wavelengths are divided between the plurality of different wavelength ranges; receiving light of a same wavelength range that is emitted from the different positions along the length of the flow cell by a same array of spherical lenses. wherein different spherical lenses within each array receives light emitted from the different positions of the flow cell; directing light from each of the spherical lenses to a different photodetector, and measuring light at each of the different photodetectors, thereby identifying the presence, absence or abundance of the markers and thus cellular moieties to characterize the biological cell.

### BRIEF DESCRIPTION OF THE DRAWINGS

FIG. 1 is a representation of a flow cytometer incorporating an exemplary optical system provided herein.

FIG. 2 is a representation depicting an embodiment for sampling fluorescently labeled cells.

FIG. 3 is a representation depicting an embodiment for splitting light into different wavelengths.

FIG. 4 is a representation of an exemplary array of spherical lenses.

FIG. 5 is a representation showing detection within a single channel.

FIG. 6 is a table of specifications for the embodiment shown in FIG. 3.

FIG. 7A depicts the focusing of light at five separate and distinct positions 18a-e along the length of the flow cell, where the different neighboring positions 18a-e are spaced 100 μm apart from one another; FIG. 7B depicts the propagation of fluorescent light emitted from the five different positions shown in FIG. 7A towards a shared focal plane 56: and FIG. 7C depicts the spacing of the fluorescent light at the shared focal plane 56 shown in FIG. 7B, where the spacing of light emitted from the neighboring locations of the flow cell is increased from 100 μm to 5.5 mm.

FIG. 8A shows another exemplary propagation of rays in the form of fluorescence from five different positions of a flow cell, where the fluorescence at the shared focal plane 56 is directed to the photodetector 52 by way of the spherical lenses 54. FIG. 8B shows the centering of the fluorescence at the photodetector 52 when the fluorescence strikes the middle of the spherical lens 54. FIG. 8C shows the centering of the fluorescence at the photodetector 52 when the fluorescence strikes the spherical lens 54 1.65 mm offset to the right but centered vertically. FIG. SD shows the centering of the fluorescence at the photodetector 52 when the fluorescence strikes the spherical lens 54 offset to the left 2.2 mm and offset downward 0.55 mm.

### DESCRIPTION OF PREFERED EMBODIMENTS

In the present disclosure, the optical design of a light collection sub-system for a spectral flow cytometer is optimized to address the following problems: (a) complex design and potential lower light collection efficiency and higher cost associated with using an array of optical fibers each of which guides light from one laser excitation to a corresponding sub-system for light splitting and light detection, (b) large signal coefficient of variation (CV) associated with existing systems, especially with high sample flow rate for high throughput cell analysis in current spectral flow cytometers with optical fiber collection of fluorescent light excited by different lasers; (c) high cost and complex light collection sub-system design associated with using multiple sets of optical filters for splitting fluorescent lights from different lasers; and (d) poor spectrum wavelength range resolution in individual fluorescence light detection channel and high cost using an array of light dispersion optical components.

For at least some of the light collection sub-systems described herein, a novel light collection optics sub-system and an innovative light splitting (transmitting and reflecting) filter set are included. For light collection, a customized objective is designed to have the high numerical aperture (e.g. larger than 1.2) with a large magnification factor (e.g. >30×). The high numerical aperture allows the collection of more fluorescent light emitted from cells or particles as they pass through the excitation laser beam. The objective with large optics magnification focuses the emitted fluorescence lights from n (n is the number of lasers in the system) lasers to separated light spots on a vertical plane, with each focused spot separated at a distance large enough to be detected using an array of n individual detectors without any mechanical interference. That is to say, the magnification factor of the objective needs to be large enough to allow sufficiently large distances between focused spots due to individual lasers. On the other hand, magnification factors that are too large would result in a larger footprint and more complex system, which is not desired for a compact system.

For light splitting, the optical filter set is designed to split the fluorescent light as excited by all the lasers in the system. The placement of the optical filter sets utilizes the focal length difference at different wavelength across the full spectrum range of the collected fluorescence light so that the light with different wavelength propagates in optical paths with different lengths. The end of such an optical path for fluorescent light of each discrete narrow wavelength range is the corresponding focal plane at which a detection module is placed. The detection module includes an array of spherical lenses, followed by an array of corresponding siPM detectors. Each of spherical lenses is placed at the focal point of the fluorescent light excited by a laser beam in the flow cell to allow the light to form a uniform distribution and to cover a largest possible area on the SiPM detectors The lens in front of the SiPM photodetectors makes the SiPM to work in its best performance condition, and can significantly reduce detection signal variability so that very good signal CVs can be achieved for each fluorescence detection channel even at the high sample flow rate.

The optical sub-systems described herein meet one or more of the following objectives: 1) A large numerical aperture of the optical collection system for maximizing light-collection. 2) An appropriately designed light-collection objective to optimize/balance the desired small footprint of the instrument (using smaller magnification factor) and the with the objective of the image of light from each exciting laser being well separated at the focusing plane (in millimeter range), where an array of discrete photodetectors can be physically placed to detect the light from each excitation laser. 3) Design of the light collection objective with a large magnification factor to allow sufficient length for light magnification path along which the optical filters can be placed for splitting the fluorescent light into continuous spectrum of different, narrow wavelength ranges. 4) A spherical lens placed at the focusing spot of the collected fluorescence light from each excitation laser after the light transmits the bandpass filter in front of the SiPM photodetector. The focal length of the spherical lens is designed carefully so that after the light passes through the spherical lens, the diameter of the light spot on the detection chip behind the spherical lens matches well with the effective detection area of the photodetector. For example, if the effective photodetector area is 3 mm×3 mm, the diameter of the light spot on the detection surface is designed to be close but less than 3 mm to be effectively detected by the photodetector.

Whilst the sophisticated design of a light collection objective is a challenge, the development and placement of the light splitting filter set demands careful engineering development and innovation. A set of discrete bandpass filters are selected and arranged in a way that the collected light is first transmitted through one bandpass filter placed with a specific angle relative to the incident light and be detected by the photodetector for one channel, and the rest of the light is reflected to the next bandpass filter. The collected side scatter light and fluorescence light are therefore transmitted in serial through a set of discrete bandpass filters and are detected by the photodetectors array after each bandpass filter. The system innovatively designs the path of light transmitted through the set of bandpass filters and the light is detected for each specific wavelength range determined by the bandpass filter. With a long focusing distance, the scatter and fluorescence light enter each bandpass filter in a small half-cone angle and are focused behind the bandpass filter. The long focusing distance allows the light to propagate in free space long enough so that a series of bandpass filters can be placed.

This configuration has several advantages: 1) It is a free-space optics, and no optical fibers are used. Not using optical fibers offers the higher light collection efficiency, higher stability of collection optics, and more operation convenience. 2) Only one set of optical filters is needed for splitting the light as excited by all the lasers. Using only one set of filters instead of N sets makes the detection system simple and largely reduces the product cost. Utilization of the same optical filters for light splitting of fluorescence excited by different lasers have a surprising benefit that fluorescent light would be split into exactly the same wavelength ranges, independent of lasers that induce the fluorescence. This is important especially for those fluorescent molecules that are excited by multiple lasers when their reference fluorescent spectra due to different lasers are obtained. Splitting fluorescent light due to different lasers with the same filters to exactly same wavelength ranges helps obtain consistent or similar reference fluorescent spectra due to different lasers and potentially helps de-convolute the measured fluorescent spectra collected for the sample stained with multiple fluorescent dyes to calculate the fluorescence signal intensity of each fluorescence dye used in the sample, using the reference, spectrum data from each individual fluorescent dye. 3) The filter set splits the light into discrete narrow wavelength range (i.e. one fluorescence detection channel) across the entire detection spectrum in free space, which significantly reduces the loss of light and improves overall light collection efficiency. 4) The system allows using of solid-state photodetectors (i.e. SiPM and APD) with good photon detection performance and reduced cost. With such design, a spectral flow cytometer system can be designed with great simplicity and significantly reduced cost but with extraordinary performance. 5) Importantly, the spherical lens offers a great advantage in providing the optimal CV of detected light signal at high sample flow rate for high throughput cell analysis. As mentioned above, the focusing spot of the fluorescence light from each excitation laser is on the first surface of the spherical lens. Because of unavoidable fluid fluctuation, each individual cell or particle in the flow channel will fluctuate in the horizontal position when the sample fluid flows through the flow channel. Therefore, the light focusing spot from each excitation laser varies in horizontal position on the first surface of each corresponding spherical lens surface. The higher sample flow rate causes larger fluid fluctuation core diameter, which means a larger sample distribution width in horizontal direction. As an example, if the fluid core diameter is 60 μm, by considering the 55× magnification of the collection optical system, the focus spot of the light collected from each excitation laser on the first surface if each corresponding spherical lens will have a spread width of 3.3 mm in horizontal direction. With the spherical lens larger than 3.3 mm in diameter, the lights from all samples can be completely collected without any loss. After transmitted through the spherical lens, the fluorescence light from each excitation laser on the photodetection chip surface maintains the same position. Therefore, the detected light signal is immune to the variation from the sample to a great extent. The size of the light on the surface of the photodetector chip can be designed to match with the effective area of the photodetector chip by properly design of the spherical lens. The detected light spot on the photodetector is not affected by the position change of the collected light focused on the first surface of the spherical lens, i.e. the detected light signal is not sensitive to the sample horizontal position fluctuation inside the flow channel. The same principle is applied to the vertical position change of the detected light as well. If a focused laser beam inside the flow cell is changed from its original vertical position, the detected light signal can always keep stable as long as the fluorescence light from this laser are all collected by the spherical lens in front of the photodetector, which is feasible by using a spherical lens with a large diameter. In summary, the spherical lens positioned at the focusing spot of each fluorescence light from each excitation laser and in front of the photodetector has a unique advantage in providing a circular light spot with uniform energy distribution and with the spot size matches the effective detection area of the photodetector. The size and position of such light spot on the surface of the photodetector does not change by the variation of position of the original light source (i.e. the fluorescence light emitted from each cell or particle inside the flow channel).

In summary, the same set of optical filters is used for all the available lasers which significantly reduces the complexity of the system and reduces the cost of the system. The light collection optics can be designed with a high numerical aperture (>1.2) to maximize the light collection from each laser which results in the great improvement of fluorescent signal detection sensitivity. In addition, the system is a free-space design and minimizes the loss of the light and reduces the needs for possible frequent services which usually is problematic if fiber optics is used. Since at the focusing spot, the light from each exciting laser is well separated in space so that an array of photodetectors, such as Silicon Photomultiplier (SiPM) and Avalanche Photodiode (APD) can be used as detectors. These solid-state photodetectors have good light detection performance (i.e., high photon detection efficiency, high gain, low dark count and low operation voltage) and also are compact, robust, and low cost.

The technical improvements, advantages and benefits described above will now be described in a series of non-limiting, detailed embodiments with reference to the drawings. It should be appreciated that like reference numerals are used to identify like elements illustrated in one or more of the figures.

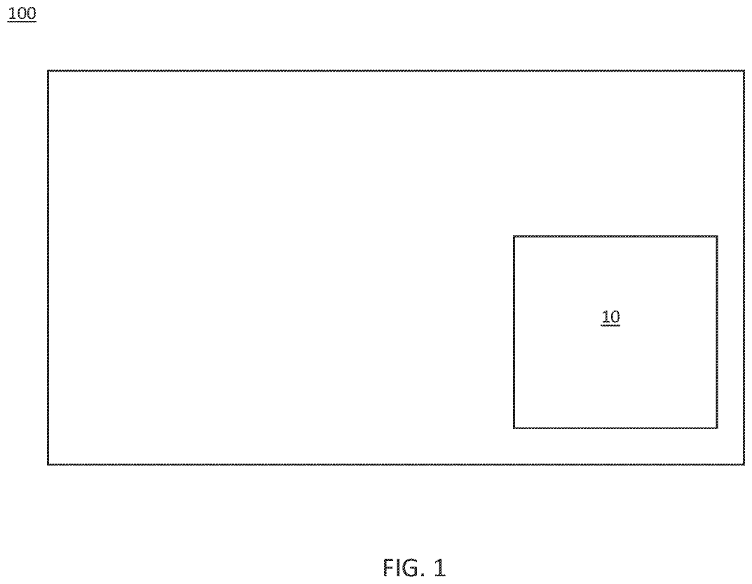

Beginning at FIG. 1, provided are optical systems 10, flow cytometers 100 incorporating the optical systems 10, and methods for measuring light, which are particularly useful for determining physical and chemical characteristics of cells labeled with fluorescent markers. The term “cell” as used herein refers a biological cell, which is the smallest unit that can live on its own and that makes up all living organisms and tissues of the body. A cell has three main parts, namely, the cell membrane, the nucleus, and the cytoplasm. The systems 10 and methods are particularly useful for profiling cells through the measurement of light emitted from fluorescent labels that target specific cell biomarkers, such as cell surface antigens or internal molecules. From the light measurements, the systems 10 and method can reveal characterizing features of the cells including cell size, cell granularity, DNA content, DNA gene expression, surface receptors, intracellular proteins and transient signaling. Moreover, from these characteristics, cell profiles can be generated according to function or activity, such as being cells that fight immune infection (e.g. B-cells., T-cells), status (e.g. cancerous compared to normal), stage (e.g. mature compared to immature), source (e.g. transgenic compared to non-transgenic), and other categories as known in the art to which the invention belongs. Moreover, compounds such as potential therapeutics, can also be characterized or profiled based on measurable changes of treated cell populations using the systems 10 and methods described herein.

As will be described in more detail in the paragraphs that follow, cell characterization and profiling can be achieved by measuring light emitted by the cell itself, which can be used to determine its size and granularity, and/or by measuring the emission from moieties that are attached to or inserted into the cell, such as fluorescently labeled antibodies, antibody fragments, or other molecules that attach to or associated with the cell and that fluoresce when excited. By assessing the presence, absence and/or abundance of these moieties, the systems 10 and methods are able to characterize and profile cells and compounds that effect cells on a single cell basis. Nonlimiting examples of such are provided throughout the disclosure.

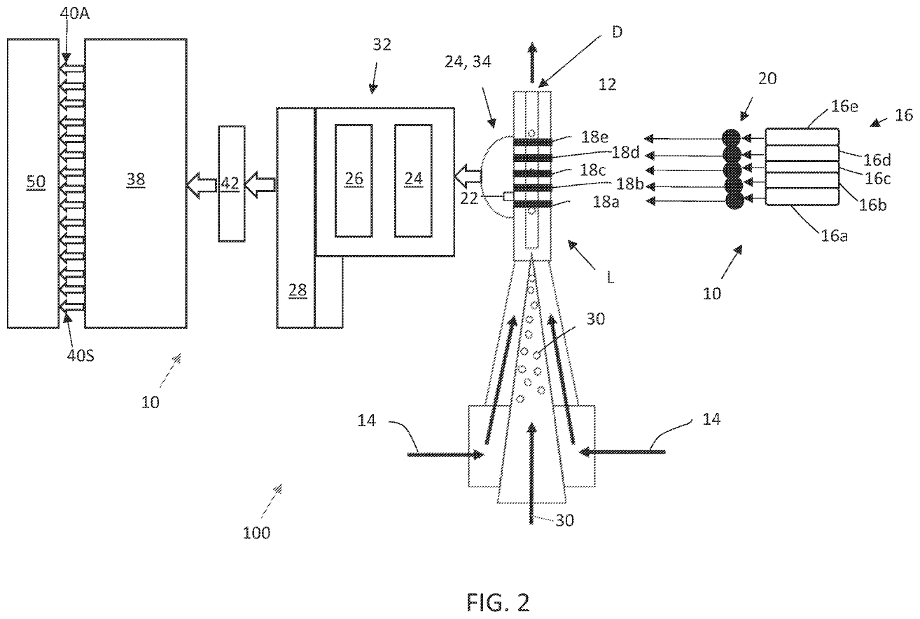

Light measurements described herein are preferably conducted on a cell-by-cell basis so that data is collected and analyzed from individual cells. Moreover, measurements are very fast, such as at speeds of about 10,000 cells per minute, Moving on to FIG. 2, which illustrates one embodiment of a flow cytometer 100 incorporating the optical system 10 in accordance with the technology of the present description, this is achieved in part by quickly passing cells through an elongated flow cell 12 that has a inner diameter D that is slightly larger than the cell itself. Sample/cells 30 can be passed through the flow cell 12 by integrating the flow cell 12 into a fluidics system that on the one hand delivers cells 30 to the flow cell 12, and on the other hand removes cells from the flow cell 12. This can be achieved using suitable fluidics pumping mechanisms known in the art to which the invention belongs, such as those used in flow cytometry systems, which transport sheath fluid 14 into and out of a flow cell 12. In some embodiments, the optical system 10 itself, and components thereof, form part of a flow cytometer 100.

As cells pass through the flow cell 12, excitation light source 16 directs light to different positions 18a-18e along the length L of the flow cell 12. This light is provided at wavelengths that cause certain moieties to fluoresce. For example, excitation light source 16a-e directs light of specific wavelengths to different positions 18a-18e along the length L of the flow cell 12. In some embodiments, the excitation light source 16 directs light having wavelengths of 349 nm, 405 nm, 488 nm, 561 nm, and 637 nm to the different positions 18a-18e along the length L of the flow cell 12. As cells pass through the different positions 18a-18e, fluorescent labels attached to the cells may fluoresce and this fluorescence is collected. resolved and measured for each of the different positions 18a-18e along the length L of the flow cell 12 for analysis.

In a preferred embodiment as detailed in FIG. 2, a single excitation light source 16 directs light to a single position 18a-18e along the length L of the flow cell 12, thereby selectively pairing each of the different positions 18a-18e along the length L of the flow cell 12 with its own excitation light source 16. For example, a first position 18a along the length L of the flow cell 12 may receive light at a first wavelength (e.g., λₐ=349 nm) from light source 16a, a second position 18b may receive light from light source 16b at a second wavelength (e.g., λ_{b}=405 nm), a third position 18c may receive light from light source 16c at a third wavelength (e.g., λ_{c}=488 nm), a fourth position 18d may receive light from light source 16d at a fourth wavelength (e.g., λ_{d}=561 nm), and a fifth position 18e may receive light from light source 16e at a fifth wavelength (e.g., λₑ=637nm). Thus, in the embodiment shown in FIG. 2, the systems 10 and methods include five excitation light sources 16a-16e; however, in other embodiments the systems 10 and methods include any number n of excitation light sources 16. In some embodiments, the systems 10 and methods include n=seven or more than seven excitation light sources 16. In some embodiments, n=ten or more than ten excitation light sources 16. In some embodiments, the systems 10 and methods include n=fifteen or more than fifteen excitation light sources 16.

In some embodiments, the excitation light sources 16 can direct light through fiber optic cables to different positions 18a-18e along the length L of the flow cell 12. In other embodiments the excitation light sources 16 are lasers aimed directly at the different positions 18a-18e of the flow cell 12. In still other embodiments, light emitted from lasers are directed to the different positions 18a-18e along the length of the flow cell 16, such as through the use of alignment mirrors. In each of the above configurations, the excitation light sources 16 may direct light through beam shaping optics 20 that alter the light's initial geometry of the light beam from circular or substantially circular to one or more designed geometries. These designed geometries may consider that, on the one hand laser beams should be shaped so they are wide enough to span the width of the flow cell 12, thereby permitting the entirety of the inner diameter D to be encompassed, and on the other hand laser beams should shaped to minimize height to reduce distances between neighboring positions 18a-18e along the length L of the flow cell 12. In some embodiments these designed geometries tend to be more elliptical rather than circular and aligned so that the major axis of the ellipse-like geometry extends across the inner diameter D of the flow cell 12 rather than along the length L of the flow cell 12. However, in other embodiments an elliptical beam geometry is formed so that the major axis of the ellipse extends along the length L of the flow cell 12.

The systems and methods resolve fluorescence signals emitted between neighboring positions 18a-18e along the length L of the flow cell 12 that are quite close to one another, such as in the range of microns. In some embodiments, the systems 10 and methods resolve fluorescence signals between neighboring positions 18a-18e along the length L of the flow cell 12 that have a separation distance 22 from 50 μm to 300 μm. In some embodiments fluorescence signal is resolved from neighboring positions 18a-18e along the length L of the flow cell 12 having a separation distance 22 from 60 μm to 250 μm. In some embodiments fluorescence signal is resolved from neighboring positions 18a-18e along the length L of the flow cell 12 having a separation distance 22 from 70 μm to 150 μm. In some embodiments fluorescence signal is resolved from neighboring positions 18a-18e along the length of the flow cell 12 having a separation distance 22 from 75 μm to 100 μm. In some embodiments fluorescence signal is resolved from neighboring positions 18a-18e along the length L of the flow cell 12 having a separation distance 22 from 50 μm to 55 μm, 55 μm to 60 μm, 60 μm to 65 μm, 65 μm to 70 μm, 70 μm to 75 μm, 75 μm to 80 μm, 80 μm to 85 μm, 85 μm to 90 μm, 90 μm to 95 μm, 95 μm to 100 μm, 100 μm to 105 μm, 105 μm to 110 μm, 110 μm to 115 μm, 115 μm to 120 μm, 120 μm to 125 μm, 125 μm to 130 μm, 130 μm to 135 μm, 135 μm to 140 μm, 140 μm to 145 pm, or 145 μm to 150 μm, 150 μm to 160 μm, 160 μm to 170 μm. 170 μm to 180 μm, 180 μm to 190 μm, and 190 μm to 200 μm.

Preferably, separation distances 22 between each of the neighboring positions 18a-18e along the length L of the flow cell 12 are the same across all neighboring positions 18a-18e. That is, the separation distance 22 between a neighboring first and second position 18a, 18b as cells flow along the length L of the flow cell 12 is preferably the same as that between neighboring second and third position 18b, 18c as cells continue to flow along the length L of 16 the flow cell 12 and so on. However, the invention is not limited as such and thus in other embodiments the neighboring separation distances 22 are not the same,

As cells 30 flow along the length L of the flow cell 12, they are exposed to light from the plurality of excitation light sources 16, which causes the emission of light. That is, cells and fluorescently labeled molecules paired with cells emit light as they are exposed to light of suitable wavelengths, which target the different positions 18a-18e of the flow cell 12. The principles of light emission and fluorescence are well known in the art to which the invention belongs and are therefore omitted for brevity.

Light emitted from the different positions 18a-18e along the length L of the flow cell 12 is collected and magnified using shared light collection optics 24 and shared magnification optics 26. By “shared collection optics” and “shared magnification optics” it is meant that light emitted from two or more, and preferably all of the different positions 18a-18e along the length L of the flow cell 12 that is intended for measurement is collected using a same one or more collecting lenses and magnified using a same one or more magnifying lenses. Light collecting lenses having a high numerical aperture (e.g. >1.2) maximizes light collection from each of the different positions 18a-18e along the length L of the flow cell 12, which significantly improves detection sensitivity.

An exemplary configuration is shown in FIG. 2, where a light collection objective 32 is integrated with both shared light collection optics 24 and shared magnification optics 26. Also shown in FIG. 2, light collection optics 24 embodied as a half ball lens 34, which is bonded to the surface of the flow cell 12 using an optical adhesive glue, passes emitted light from the flow cell 12 into the light collection objective 32. Preferably this half ball lens 34 is not glued to the light collection objective 32 so that the light collection objective 32 can be moved along three different axes for compensating variability in light emission positions, due to differences in fluid dynamics and alignment of the excitation light sources 16. Upon entering the light collection objective 32, the emitted light is passed through a set of lenses, some of which can be converging lenses and others diverging lenses to achieve the desired magnification and focal length. Broadly, converging lenses tend to be thicker in the middle and direct light rays passing through the lens towards a focal point; whereas, diverging lenses tend to be thinner in the middle and have a negative focal length so that light rays exiting the lens are spread apart from one another. By combining different lenses in series, the magnification of the light collection objective 32 can be 20× to 250×. In some embodiments, the magnification of the light collection objective 32 is 30× to 100×. In some embodiments, the magnification of the light collection objective 32 is 40× to 60×. In some embodiments the magnification of the light collection objective 32 is 40×, 41×, 42×, 43×, 44×, 45×, 46×, 47×, 48×, 49×, 50×, 51×, 52×, 53×, 54×, 55×, 56×, 57×, 58×, 59× or 60×. In some embodiments, light entering the light collection objective 32 passes through two convex-concave lenses. followed by a half ball lens, then a double convex lens and results in a magnification of 40× to 60×.

In some embodiments, the objective 32 may be adjusted in three axes by mounting it on a X-, Y- and Z-stage 28. The 3-axis alignment of the objective 32 may be used to compensate for tolerances of light emission positions.

While one objective is to magnify all light emitted from the flow cell 12 that is subsequently intended for splitting and measurement, it also important to ensure the light emitted from each of the different positions 18a-18e along the length of the flow cell 12 remains identifiable from the others. This can be achieved by combining divergent lenses, which again spread light outward, and one or more collimating lens, which narrows the cross section of each beam and redirects the light along a same path. Examples of collimating lenses are known in the art and include various plano-convex lenses.

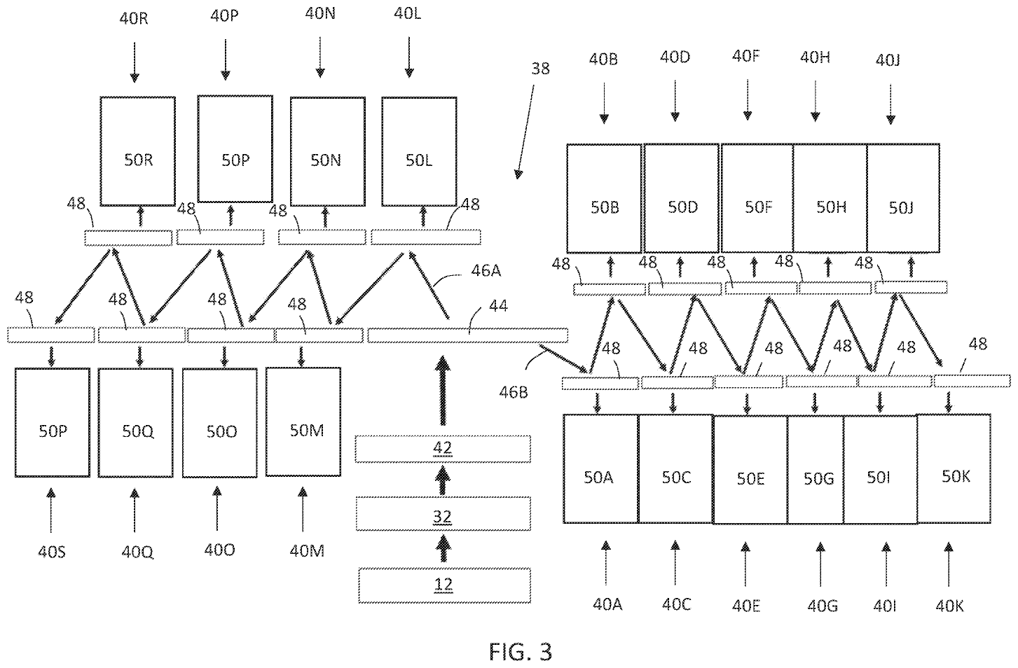

Light emitted from the different positions 18a-18e along the length L of the flow cell 12 passes from the shared light collection optics 24 and shared magnification optics 26 of the light collection objective 32 to additional optics (e.g., reflective mirrors 42) and a light splitting module 38, which includes light splitting optics configured to split the magnified light into a plurality of different wavelength ranges (e.g., 40A-40S) prior to being received by detection module 50. Light splitting module and detection module are shown more clearly in FIG. 3, and accommodate different channels 40A-S (collectively referred to as an “array of channels”) for measurement. For spectral flow cytometer of the present invention, such different fluorescent channels with the array or different wavelength ranges are actual continuous, i.e. counting fluorescent channels from short to long wavelength ranges, for two neighboring channels, the longer wavelength end of a short range is the same as ‘the shorter wavelength end of next long wavelength range channel’. In one exemplary embodiment, wavelength ranges of the channels are: 371 nm-389 nm, 417 nm-431 nm, 431 nm-449 nm, 449 nm-461 nm, 461 nm-477 nm, 500 nm-517 nm, 517 nm-534 nm, 534 nm-552 nm, 573 nm-592 nm, 592 nm-608 nm,608 nm-628 nm, 650 nm-672 nm, 672 nm-691 nm, 691 nm-709 nm, 709 nm-726 nm, 726 nm-744 nm, 744 nm-770 nm, 770 nm-798 nm, 798 nm-920 nm. Evidently, there are a few wavelength gaps, corresponding to laser wavelengths, i.e. the gap of 389 nm-417 nm for 405 nm laser, 477 nm-500 nm gap for 488 nm laser, 552 nm-573 nm gap for 562 nm laser, and 628 nm-650 nm gap for 637 nm laser. Proper alignment of the light collection objective 32 with the light splitting module 38 is ensured by a pair of reflective mirrors 42, which can be adjusted in different directions.

In preferred embodiments, the light splitting module 38 includes a short pass or long pass filter 44, which initially splits the received light into one of two different paths of propagation 46A and 46B through the light splitting module 38. It is appreciated that the filter 44 may be configured based on the number m of desired channels 40. Based on the configuration of M=19 channels (40A-40S) channels shown in FIG. 3, two paths of propagation 46A and 46B were implemented. However, it is also within scope of the invention for all light to proceed along a same path of propagation or to be split repeatedly for passing the light between three or more paths of propagation. Nonetheless, along each path of propagation 46A, 46B is aligned a series of bandpass filters 48. Each bandpass filter 48 is designed to permit the passage of light having a specific wavelength while refusing passage of remaining wavelengths. These refused wavelengths attenuate along the path of propagation 46A, 46B through the light splitting module 38, and thus encounter a next bandpass filter 48 and so on. Accordingly, alignment of bandpass filters 48 relative to incidence light is crucial to ensure the continued propagation of excluded wavelengths through the light splitting module 38. As a nonlimiting example, it has been found that arranging bandpass filters 48 to an angle between 10° to 20° can achieve continued propagation. However, angling each bandpass filter 48 at an angle relative to incidence light of 12° to 16° is more preferred, while an angle relative to incidence light of 14° or 15° is currently the most preferred. Thus, by propagating the magnified light from each of the different positions 18a-18e of the flow cell 12, the emitted light can be split into a plurality of different detection channels 40A-S, each corresponding to a particular wavelength range. Moreover, since the collection optics 24 and magnification optics 26 are shared across the different positions 18a-18e along the length L of the flow cell 12, emission from these different positions 18a-18e can be propagated in the same direction and thus through a same set of bandpass filters 48. As such, bandpass filters 48 can be shared by light emitted from each of the different positions 18a-18e of the flow cell 12, which itself reduces the footprint of the light splitting module 38.

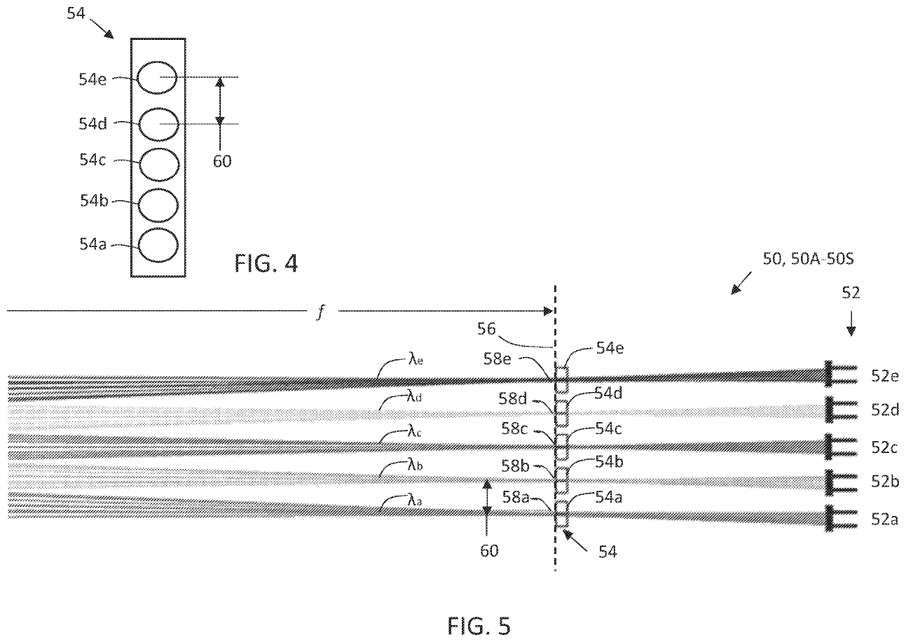

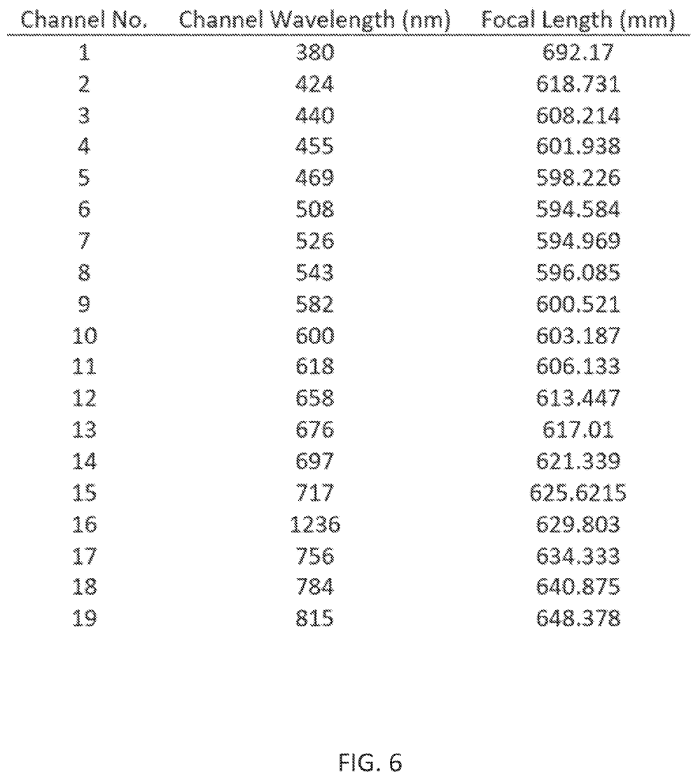

Light passing through each if the different bandpass filters 48 is received by an array of light detection modules 50 In the embodiment shown in FIG. 3, a dedicated light detection module (50A-50S) is coupled to each of the m channels (40A-40S). Thus, the number of light detection modules within array 50 corresponds to or matches the number m channels generated by light splitting module 38. As illustrated in FIG. 4, and FIG. 5, each light detection module 50 will include or be coupled to a dedicated array 54 of spherical lenses, which subsequently directs the magnified light from each of the different positions 18a-18e along the length L of the flow cell 12 to predetermined photodetector arrays 52 for measurement. That is, an array 54 of spherical lenses is assigned to each of the channels 40A-40S defined by the corresponding bandpass filter 48 and positioned along a path of propagation that traverses the bandpass filter 48 at a specified distance determined from the wavelength and optics so that each of the spherical lenses 54a-54e within a same array 54 (shown in FIG. 4) is configured to receive light of a same wavelength range. However, each of the spherical lenses 54a-54e within the array 54 receives light emitted from a different excitation light source 16a-16e (with corresponding assigned wavelengths (λₐ, λ_{b}, λ_{c}, λ_{d}, λₑ) and positions 18a-18e along the length L of the flow cell 12 (see FIG. 2)). That is, the array of spherical lenses 54 not only receives and directs light of a certain wavelength range (according to its channel) to a detector 52 for measurement but also distinguishes between light emitted from each of the different positions 18a-18e along the length L of the flow cell 12 for measurement.

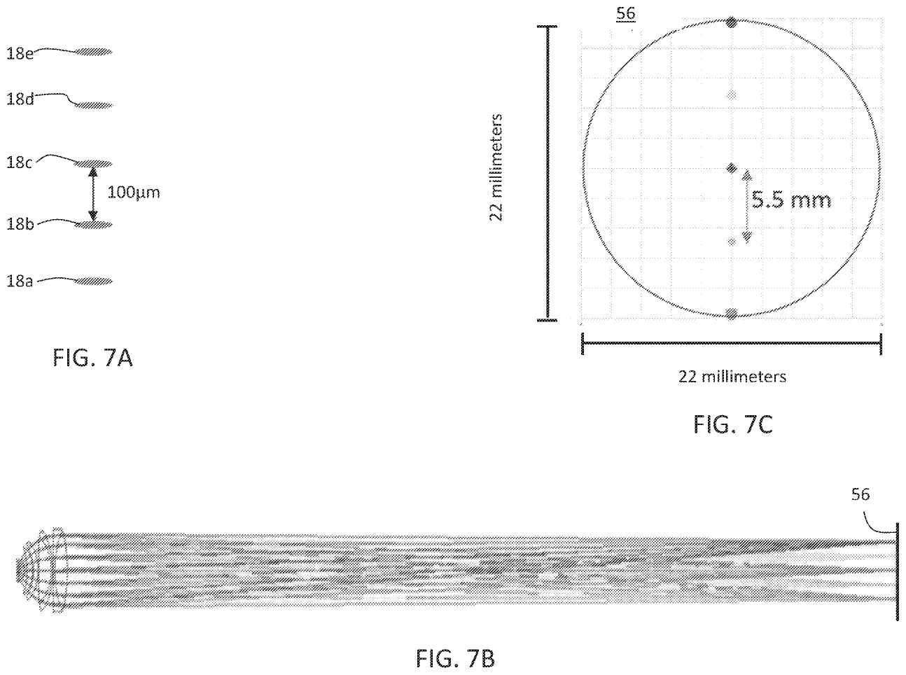

Positioning and thus the specified distance of the array of spherical lenses 54 is determined based on the focal length of light passing through the corresponding bandpass filter 48. That is, each of the spherical lenses 54 within a same array is arranged on a same plane 56 (also referred to herein as a “focal plane”). This same plane 56 corresponds to the focal length f of light assigned to the channel 40A-S, which is itself determined by the focal length of the shared collection optics 24, shared magnification optics 26, and the bandpass filter 48. That is, the array 54 of spherical lenses 54a-54e is positioned at the focal points 58a-58e on the plane 56 for each channel 40A-S. An example is shown in FIG. 6, which is a table summarizing exemplary focal lengths f of nineteen (19) channels (e.g., channels 40A-40S) and the positioning of nineteen arrays 54 of spherical lenses (54a-54e).

For example, the first listed channel 1 in FIG. 6 corresponds to channel 40A illustrated in FIG. 3, which has a focal length f_{A}=692.17 mm for the wavelength of 380 nm (the middle of the range of 371 nm-389 nm for channel 40A), wherein the spherical lens array 54 assigned to the light detection module 50A is positioned in the focal plane 56 at focal length f_{A}=692.17mm. Thus, there are f_{M} focal lengths corresponding to 40_{M} channels and 50_{M} detection modules. For the system of FIG. 2 and FIG. 3 having M=19 channels and n=5excitation light sources, a total of M×n (19×5)=95 detectors and spherical lenses are used.

In the above example, with a 55× magnification of collection optics and separation distance 22 of 100 μm (FIG. 3), the vertical separation 60 between two adjacent light focusing spots (focal points 58a-58e) is 5.5 mm. Thus, the spherical lenses 54a-54e are aligned in the focal plane 56 to be 5.5 mm (C-C) vertically spaced from each other.

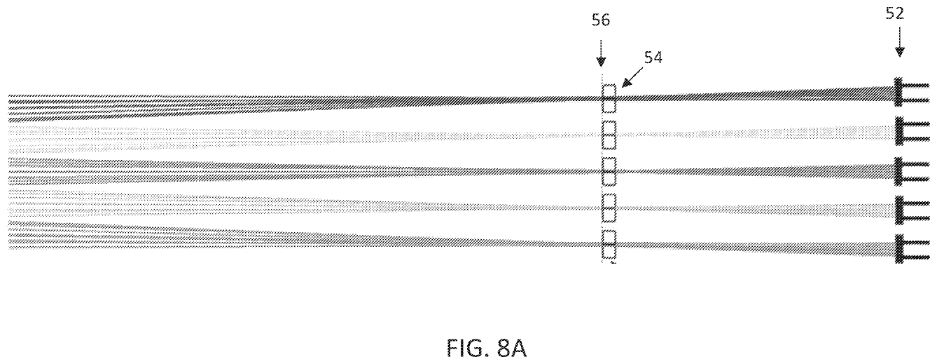

Referring now collectively to FIGS. 1-7C, although each of the spherical lenses 54a-54e within a single array of spherical lenses 54 is aligned along a same plane 56 as one another, the array of spherical lenses 54 also distinguishes between light emitted from each of the different positions 18a-18e along the length L of the flow cell 12 by assigning each spherical lens 54a-54e within the array 50 to a different focal point 58a-58ₑ within the focal plane 56. Each of these focal points 58a-58e within the focal plane 56 is the result of collection and magnification of light emitted from the different positions 18a-18e along the length L of the flow cell 12. Shown more clearly in FIGS. 7A-7C, resolving fluorescence emitted from different positions 18a-18e along the length of the flow cell includes expanding the separation distances between neighboring positions 18a-18e. For example, light may be emitted from neighboring positions 18a-18e that are only spaced 100 μm apart (see FIG. 7A). Such small distances are difficult to resolve. However, by propagating the emitted light through an array of different lenses (see FIG. 7B), the separation distances can be significantly expanded (FIG. 7C depicts a separation distance of 5.5 mm at the focal plane). This increased separation distance at the focal plane 56 permits the spherical lenses 56a-56e to resolve the signal from each of the different positions 18a-18e along the length of the flow cell for transfer to the photodetector 52. That is, light emitted from each of the different positions 18a-18e of the flow cell 12 is ultimately focused as spots of light, each at a different focal point 58a-58e along the focal plane 56 and by positioning a spherical lens 54a-54e at that point 58a-58e, the emitted light can be subsequently directed to the predetermined area of a dedicated photodetector 52a-52e for measurement. Directing emitted light to a specific focal point 58a-58e along a focal plane 56 is achieved by maintaining the identity or source of light throughout the light splitting module 38. Because the flow cell 12 is typically arranged vertically, as shown more clearly in FIG. 4, the spherical lenses 54a-54e are also typically arranged vertically offset from one another. In some embodiments the vertical separation distance 60 between neighboring light (i.e. neighboring focal points 58a-58e) at the array of spherical lenses 50 is less than 30 mm. In some embodiments, the vertical separation distances 60 between neighboring focal points 58a-58e are from 1 mm to 10 mm. In some embodiments, each of the vertical separation distances 60 between neighboring focal points 58a-58e is 5.5 mm.

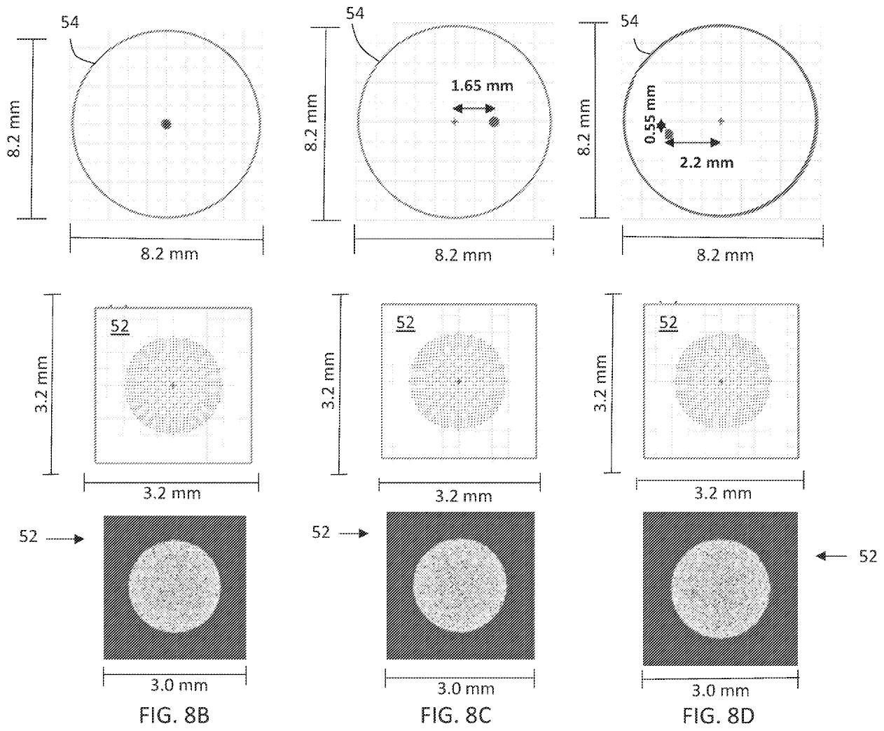

Each spherical lens 54a-54e within each array of spherical lenses 54 directs received light to a different photodetector 52a-52e for measurement, thereby permitting measurement based on emission wavelength and emission position from the flow cell 12. Among the challenges encountered in delivering light from flow cell 12 to detector 52 is miniaturization, at least in part due to the uneven flow or wobbling of cells as they pass through the flow cell 12. That is, inconsistencies were initially found when passing cells through the flow cell 12 due to varying fluidic properties and positioning of excitation light sources 16. These inconsistencies were magnified throughout the system, which presented a significant challenge in the manufacture of a flow cytometer 100 with a small footprint. This problem was solved in part through the use of spherical lenses 54a-54e within the array of spherical lenses 54, which correct for inconsistencies in optical alignment to the appropriate photodetector 52a-52e. Correction of inconsistencies is demonstrated experimentally in FIGS. 8A-D. For reference throughout FIGS. 8A-D, FIG. SA depicts a terminal portion of the propagating fluorescence through the system where the propagating light rays are directed to the detectors 52 by way of the spherical lenses 54 positioned at the focal plane 56. FIG. 8B depicts results from ideal alignment where the propagated light strikes the center of the spherical lens 54 and is therefore directed to the predetermined or effective region of the photodetector 52. Again, due to various factors, in some instances the light strikes the spherical lens 54 off center. FIG. 8C shows results where the light strikes the spherical lens 54 1.65 mm horizontally off center (to the right). Due to the radius of the spherical lens 54, the light can be redirected to the predetermined or effective region of the photodetector 52. FIG. 8D shows results where light strikes the spherical lens 54 2.2 mm off center horizontally (to the left) and 0.55 mm off center vertically (downward). In this instance, the spherical lens 54 corrects the path of propagation so that again the light strikes the predetermined or effective region of the detector 52. This correction or redirection in instances where the light strikes the spherical lenses 54 off center is accomplished at least in part by the radius of the spherical lenses 54. In the demonstration depicted in FIGS. 8A-D, the spherical lenses 56 each have of a radius of 4.1 mm to direct or redirect the light to a predetermined or effective region of less than 3 mm×3 mm. In view of the above, the artisan would recognize that the radius of the spherical lens 54 could vary depending at least partly on the predetermined or effective area of the detector 52 as well as the spacing difference of the propagating light. Thus, the radius is not limited to any particular size but as general guidance from which to begin, the radius can be from 1 mm to 20 mm, such as 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, or any size therebetween.

The photodetectors 52a-52e (collectively referred to as an “array of photodetectors”). which may comprise silicon photomultiplier (SiPM), avalanche photodiode (APD), or the like detectors, are collected into a number of M light detection modules 50 each comprising an array of n photodetectors so that one photodetector 52a-52e of each light detection modules 50A-50S measures light corresponding to a single wavelength range within channels 40A-40S and from one of the different positions 18a-18e along the length L of the flow cell 12. By measuring light at each channel 40A-40S and from each of the different positions 18a-18e along the length L of the flow cell 12, the systems 10 and methods are able to identify the presence, absence and/or abundance of fluorescent markers and thus determine cellular moieties used to characterize the cell.

The foregoing description of various embodiments of the technology of the present disclosure has been presented for purposes of illustration and description. It is not intended to limit the technology of the present disclosure to the precise forms disclosed. Many modifications, variations and refinements will be apparent to practitioners skilled in the art. For example, embodiments of the device and optics therefor can be sized and otherwise adapted for various detector and/or flow cell configurations. Further, those skilled in the art will recognize, or be able to ascertain using no more than routine experimentation, numerous equivalents to the specific devices and methods described herein. Such equivalents are considered to be within the scope of the present technology of the present disclosure and are covered by the appended claims below.

Elements, characteristics, or acts from one embodiment can be readily recombined or substituted with one or more elements, characteristics or acts from other embodiments to form numerous additional embodiments within the scope of the technology of the present disclosure. Moreover, elements that are shown or described as being combined with other elements, can, in various embodiments, exist as standalone elements. Hence, the scope of the technology of the present disclosure is not limited to the specifics of the described embodiments, but is instead limited solely by the appended claims.

What is claimed is:

1. An optical system for measuring light, the system comprising:
a) a flow cell having a length and a width that permits passage of biological cells;
b) a plurality of different excitation light sources that direct light to different positions along the length of the flow cell;
c) shared light collection optics and shared magnification optics configured to collect light emitted from the different positions of the flow cell and to magnify and focus the collected light on a focal plane of a specified distance according to different wavelength ranges, and to different positions along the focal plane according to each of the different positions of the flow cell from which light is emitted;
d) a light splitting module comprising light splitting optics arranged in a way so that the light splitting optics are shared by the magnified light emitted from each of the different positions of the flow cell, and the light splitting optics are configured to split the magnified light emitted from each of the different positions of the flow cell into an array of channels, each channel corresponding to a separate wavelength range;
e) an array of detection modules, wherein each detection module is dedicated to an individual channel within the array of channels, each detection module comprising:
i) an array of spherical lenses located at each of the different focusing distances along a direction of propagation of the collected light for each of the different wavelength ranges, each of the spherical lenses within the array configured to receive the magnified light emitted from one of the different positions of the flow cell and to direct the received magnified light to a predetermined area on a corresponding photodetector, and
ii) an array of photodetectors configured to measure the magnified light directed from each of the spherical lenses, thereby one photodetector measuring the collected light within one wavelength range from one of the different positions of the flow cell.

2. The system of claim 1, wherein the plurality of excitation light sources comprises a plurality of laser light sources.

3. The system of claim 2, wherein the laser light sources are shaped by beam shaping optics to designed geometries and focused to different positions inside the flow cell.

4. The system of claim 1, wherein the plurality of different excitation light sources comprises more than 5 excitation light sources, optionally more than 10 excitation light sources, optionally more than 15 excitation light sources.

5. The system of claim 1, wherein a distance between neighboring positions on the flow cell to which light is directed from the excitation light sources is from 25 μm to 250 μm, optionally 50 μm to 150 μm.

6. The system of claim 1, wherein the shared light collection optics direct light to the shared magnification optics, which magnify vertical separation distances between light emitted from the different positions of the flow cell.

7. The system of claim 6, wherein the shared magnification optics comprise a set of objective lenses comprising a magnification of 20× to 250×, optionally 30× to 100×, optionally 35× to 75×, optionally 40× to 60×.

8. The system of claim 6, wherein the vertical separation distances between neighboring light at the array of spherical lenses is less than 30 mm.

9. The system of claim 8, wherein the vertical separation distances at the array of spherical lenses are from 1 mm to 10 mm.

10. The system of claim 9, wherein the plurality of excitation light sources direct light to neighboring positions along the flow cell that are 100 μm apart, the shared magnification optics comprise 55× magnification, and neighboring light received at the array of spherical lenses is separated 5.5 mm apart.

11. The system of claim 1, wherein the light splitting module propagates light through a series of dichroic mirrors and band pass filters to split the magnified light into the plurality of different wavelength ranges.

12. The system of claim 1, wherein the plurality of wavelength ranges comprises wavelength ranges from 320 nm to 1000 nm.

13. The system of claim 12, wherein the excitation light sources comprise of lasers of 349 nm, 405 nm, 488 nm, 561 nm, and 637 nm.

14. The system of claim 12, wherein the different wavelength ranges comprise 372 nm to 389 nm, 417 nm to 431 nm, 431 nm to 449 nm, 449 nm to 461 nm, 461 nm to 477 nm, 500 nm to 517 nm, 517 nm to 534 nm, 534 nm to 552 nm, 573 nm to 592 nm, 592 nm to 608 nm, 608 nm to 628 nm, 650 nm to 672 nm, 672 nm to 691 nm, 691 nm to 709 nm, 709 nm to 726 nm, 726 nm to 744 nm, 744 nm to 770 nm, 770 nm to 798 nm, and 798 nm to 832 nm.

15. The system of claim 1, wherein the light emitted from the different positions wobbles in response to varying fluidic properties through the flow channel and/or changes in positioning of excitation light sources.

16. The system of claim 15, wherein the spherical lenses with each array direct wobbling light to a same area of the photodetector where the detected light is stable.

17. The system of claim 1, wherein the photodetector system comprises a silicon photomultiplier (SiPM) detector.

18. The system of claim 1, wherein each spherical lens is specifically designed so that the diameter of a spot of light on the photodetector corresponds with an effective detection area of the detector.

19. The system of claim 1, wherein the collection optics and spherical mirrors are specified such that a detected light spot on a corresponding photodetector is not affected by a positional change of the collected light focused on the spherical lens.

20. The system of claim 1, wherein spherical lenses are designed so that the detected light signal on the corresponding photodetector is not sensitive to a horizontal position fluctuation of the biological cells inside the flow channel.

21. The system of claim 1, further comprising a set alignment optics configured to align the magnified light into the light splitting module and the arrays of spherical lenses.

22. A flow cytometer comprising the system of claim 1.

23. A method of characterizing a biological cell, the method comprising:
a) passing a biological cell through a flow cell, the biological cell labeled with a plurality of fluorescent markers that fluoresce at different wavelengths when excited, the labels attached to or absent from cellular moieties that together characterize the biological cell by the presence, absence or abundance of the markers;
b) directing light to different positions along a length of the flow cell as the biological cell passes the different positions;
c) collecting light emitted from each of the different positions of the flow cell as the biological cell passes;
d) magnifying and focusing the collected light to different focusing distances according to different wavelength ranges, and to different positions within each focusing distance according to each of the different positions of the flow cell from which the collected light is emitted;
e) splitting the magnified light into a plurality of different wavelength ranges, wherein the different fluorescent wavelengths are divided between the plurality of different wavelength ranges;
f) receiving light of a same wavelength range that is emitted from the different positions along the length of the flow cell by a same array of spherical lenses, wherein different spherical lenses within each array receives light emitted from the different positions of the flow cell;
g) directing light from each of the spherical lenses to a different photodetector; and
h) measuring light at each of the different photodetectors, thereby identifying the presence, absence or abundance of the markers and thus cellular moieties to characterize the biological cell.
